(19) United States
(12) Patent Application Publication
(10) Pub. No.: US 2014/0349146 A1
(43) Pub. Date: Nov. 27, 2014

(54) BATTERY HAVING A PLURALITY OF ACCUMULATOR CELLS AND METHOD FOR OPERATING SAME

(71) Applicant: Albright Deutschland GmbH, Bremen-Huchting (DE)

(72) Inventor: Ralf Dittmann, Bremen (DE)

(73) Assignee: Albright Deutschland GmbH, Bremen-Huchting (DE)

(21) Appl. No.: 14/354,268

(22) PCT Filed: Oct. 16, 2012
(86) PCT No.: PCT/EP2012/070499

§ 371 Date: Apr. 25, 2014

(30) Foreign Application Priority Data
Oct. 25, 2011 (DE) 10 2011 054 790.8

(51) Int. Cl. H01M 10/04; H01M 10/42

(52) U.S. Cl. CPC H01M 10/0445; H01M 10/425; H01M 2220/20; H01M 2010/4271
USPC 429/50; 429/158

(57) ABSTRACT

A battery (100) has first accumulator cells (111 . . . 114) connected in series to form at least one cell string (110), and second accumulator cells (121 . . . 124) are arranged so that cells can be connected in parallel to individual cells of the first accumulator cells (111 . . . 114) by switching elements (131 . . . 133′, 134, 134′). To compensate the charge between the cells, the switching elements (131 . . . 133′, 134, 134′) can establish two-way connections (A, B) between the first and second accumulator cells. Each second accumulator cell (121) can be connected in parallel alternately either to a first accumulator cell (111) within the cell string (110) or to another adjacent first accumulator cell (112). The switching elements (131 . . . 133′, 134, 134′) are controllable and alternately establish the two-way connections (A, B) between the first and second accumulator cells at predefined time intervals (TA, TB) so that each second accumulator cell (121) is connected in parallel to one first accumulator cell (111) in a first time interval (TA) and to the other first accumulator cell (112) in a second time interval (TB).

### BACKGROUND

1. Field of the Invention

The invention relates to a battery having a plurality of accumulator cells according to the preamble of claim 1 and to a method for operating such a battery according to the preamble of the independent claim. In particular the invention relates to a battery (with rechargeable secondary cells) that comprises a plurality of identical accumulator cells which are connected with each other in series to form one or more strings or chains in order to substantially specify the desired operating or supply voltage. For that matter, multiple strings can be connected in parallel with each other to increase the capacity and the power of the battery. The invention is particularly directed to the construction of a powerful battery, such as a multi-cell lithium-ion battery.

2. Description of the Related Art

Batteries with multiple accumulator cells, in the following just referred to as cells, are well known. For several years, batteries are known which have a flexible array structure that is enabled to activate or deactivate individual cells within the array. For example, from WO 03/041206 A1 there is known an array structure, referred to as “digital battery”, comprising a plurality of cells that can be connected to each other in series and in parallel by switching elements. For example, an array may have N=9 times M=6 cells, wherein N cells respectively can be connected in series to form a string. At most M=6 strings can thus be formed and can be connected in parallel. The switching elements are located between the cells and are arranged in a matrix form. This allows different switching pathways to be activated, and thus allows, in case of failure of individual cells, to take out these cells from the active circuitry, and thus provide to maintain the operational performance. Moreover, there are shorter or longer switchable lines (paths) that can be activated to realize/present different operating voltages and/or capacities. These can be tapped from bus-shaped connecting lines.

Accordingly, a battery having a plurality of accumulator cells is known, of which N first accumulator cells are connected in series to a cell string (for example, the top string), said N second accumulator cells (i.e. the cells from another string) are arranged to be connected, by means of switching elements, in parallel arranged to each of the N first accumulator cells.

This known battery indeed comprises a flexible structure that allows to realize different voltages and capacities. Moreover, defective cells can be deactivated. However, this type of battery, like any conventional battery, has the problem that prior to the occurrence of defects in single cells, it must be ensured that each individual intact cell has to be prevented from over-voltage during charging and from under-voltage during discharging of the cell.

In order to achieve this object, there are known so-called load balancing methods (charge balancing) which ensure that the cells which are connected in series show a uniform charge state as much as possible. These techniques are especially important in high-performance batteries such as lithium-ion batteries, which, to achieve higher module voltages, comprise a plurality of cells, which are connected in series to one or more strings. To protect the individual cells from over-voltage (overcharge) or low-voltage, there are used so-called cell balancing methods and devices enabling a charge balancing among the individual cells being connected in series with each other.

The following different methods for charge balancing are known:

In the so-called shunting method fully charged cells are bridged by a bypass, resulting in a discharge current for each cell being bridged. The method is continued until the voltages of all cells within the string have, as much as possible, the same level and thus the charge of the cells has a balanced level (the cells are balanced). The advantages of this method that should be mentioned are: low-cost feasibility and low EMC problems caused by the low switching frequency. However, this method only works satisfactorily in batteries with a cell chemistry, which shows a voltage-charge characteristic with a steep characteristic curve (e.g. LiCo02), because the state of charge is estimated from the open-circuit voltage. The method therefore works only when the battery is at rest and the SOC (State of Charge, charging state) has a high value. During operation of the battery, the shunting method is not applicable. A further disadvantage is that the charge balance is lossy, because the excess charge is converted by a resistor (shunt) into thermal energy.

In the so-called capacitive-load-pump method, a portion of the charge of the cells having a higher charge state (higher voltage) is discharged by capacitors and transferred via switches to neighboring cells. This method is relatively cheap and easy to implement. It assumes, however, that the charge differences between the cells are only minimal because via the capacitors only relatively small amounts of energy can be transported. In addition, the switching frequency must be high, in order to achieve a certain effectiveness. A balancing with this method is almost impossible when there is a great cell asymmetry.

The inductive methods, using coils or transformers, work in different operating states of the battery. Due to the use of inductive components, this approach, however, is quite expensive, more complex and larger than the shunt method or the charge pump method. Further to this, the EMC problem is increasing due to the clocked circuit principle.

From the patent document U.S. Pat. No. 6,157,165 a method for operating a battery is known, wherein switching elements are provided that can selectively switch a capacitor (see “capacitor 111” in FIG. 1) in parallel to the individual accumulator cells of the battery (see “unit batteries 101 to 101c”) to charge the capacitance with the current cell voltage of the battery cell. An interconnection to a voltage detector allows to measure the cell voltages, wherein a further capacitor (“capacitor 104”) is provided to eliminate variations in voltage, namely oscillating portions of the measuring voltage.

The patent U.S. Pat. No. 7,193,390 B2 discloses a method for operating a battery wherein switching elements are provided that selectively switch capacities (see “capacitors C1 and C2” in FIG. 4) in parallel to the individual accumulator cells of the battery (see “battery cells E1 and E2”) or that can switch them to each other. First, the first capacitor (“C1”) is switched in parallel to the first cell (“EL”) and is charged with the cell voltage. Then, the capacity of the cell is disconnected and switched in parallel to the second capacitor (“C2”), so that both capacitors have the same voltage. Thereafter, the second capacitor is disconnected and is switched in parallel with a voltage-measurement device (“voltage detecting circuit”) in order to measure the voltage. Since one terminal of the second capacitor is connected to ground potential, the voltage of the cell (“E1”) can be measured stably.

These known methods have the disadvantage that the use of additional components, such as capacitors, coils or transformers, is needed, resulting in a great expenditure, in particular in terms of material and costs.

The charge balancing methods are applied to a great extent to batteries used for industrial drive technology (such as electric mobility) and for stationary energy storages, because these batteries must meet high requirements in terms of reliability, durability and safety. Industrial applications are often used in the context of uninterrupted continuous operation. Thus a defined idle state during which the cells can be balanced does not exist. Further it may occur in certain applications that the final charge status or the discharge state will not be reached. This makes it difficult or even impossible to determine the state of charge by balancing methods, because no cyclic recalibration can be performed on the fully charged or empty condition.

It is therefore an object of the invention to develop a battery of the aforementioned type in such a way that the aforementioned drawbacks are overcome in an advantageous manner. In particular a battery and a method of operating the battery shall be proposed, which allow an effective and cost-saving charge balancing/compensation within the cell structure.

### SUMMARY OF THE INVENTION

Accordingly, there are switching elements used within in the battery, the switching being adapted to establish two-way connections between the first and second battery cells, wherein each of the second battery cells is switched in parallel alternately to a first accumulator-cell within the first battery string or to another first accumulator-cell being adjacent thereto, wherein the second accumulator cells being switched by the switching elements are connected together in series to a second cell string that is connected in parallel to the first cell string. The second cell string thus constitutes a string with complete energy storage function.

Further, a method of operating such a battery is proposed, wherein N storage accumulator cells are switched together in series to form at least one (first) cell line (string 110) and wherein N second accumulator cells are arranged, each of which being switchable by switching elements to be connected in parallel with individual cells of the N first accumulator cells to form a second line (string 120), by establishing two-way connections between the first cells of the string 110 and the second cells of the string 120 by using the switching elements, wherein each second accumulator cell is alternately switched in parallel either to a first accumulator cell or to an adjacent accumulator cell within the string (string 110) adjacent the first accumulator cell is connected in parallel.

By means of the invention a charge equalization (balancing) is achieved which can be even carried out exclusively with the aid of the accumulator cells by having the cells of said one string (string 120) flexibly interconnected with the cells of the other string (string 110). Each cell of the string 120 is alternately associated with a particular cell of the string 110 and with an adjacent cell of the string 110, and may alternatively be connected in parallel to one or the other cell, so that the alternating parallel switching results in a balancing of the charge states among the cells of the string 110 causes and also balances the string 120. Thus the battery of the invention comprises two or more alike strings each including N cells. Each string has the same number of cells and constitutes a complete energy function. The cells of the second string are switched alternately to the at least one first string in a shifted manner being shifted by one cell position. Thus an two-way balancing is produces without the need of additional charge storage elements, such as capacities or coils. The cells of the string 120 constitute a complete galvanic series which is arranged in parallel to the string 110 and thus fully contributes to the overall capacity of the battery.

The inventive battery is to be particularly well suited for industrial traction applications and stationary energy storages. It also shall achieve a balancing of the cells during the continuous operation of the battery, where also a determining of the state of charge can be applied by balancing methods, if necessary.

Accordingly, it is advantageous if the switching elements are controllable or can be controlled and if in predetermined time intervals the two-way connections are continuously and alternately established between the first and second accumulator cells, wherein each of the second accumulator cell in a first time interval is connected in parallel with the first accumulator cell and in a second time interval is connected in parallel with the adjacent first accumulator cell. Thus a constant reciprocating toggling results in regard to the assignment of the cells of the string 120 to the cells of the string 110.

It is also advantageous if at least one cell of the second accumulator cells is connected with several switching elements which are designed to disconnect this second accumulator cell from circuitry with the first and/or second accumulator cell for at least a predeterminable third time interval and to connect it with a measurement device. Thereby this cell can be used temporarily for measurement purposes. In particular, state of charge and capacity can be accurately determined in order to optimize the battery management.

In the method of operating the battery, the switching elements are preferably controlled, in particular by a processor-controlled unit, wherein the two-way connections are continuously established between the first and second accumulator cells in an alternating manner within predefinable time intervals, in particular within time intervals of equal length, wherein each second accumulator cell (in the string 120) is connected in parallel with a first accumulator cell (in string 110) in a first time interval and is connected in parallel with the adjacent first accumulator cell (in the string 110) in a second time interval. The second accumulator cells are c though connected in series to a second cell string (line 120) which is switched in parallel to the first cell string (line 110).

The invention will further be described in detail by means of embodiments, wherein reference is made to the accompanying drawings representing the following schematic illustrations.

### BRIEF DESCRIPTION OF THE DRAWINGS

FIG. 1 shows the schematic structure and the structure of an inventive battery.

FIG. 2a shows the battery of FIG. 1 in a first switching state.

FIG. 2b shows the battery of FIG. 1 in a second switching state.

FIG. 2c shows suitable for FIGS. 2a/b a schematic timing chart illustrating the alternating switching states.

FIG. 3 illustrates the battery of FIG. 1 in a state during a measurement interval.

FIG. 4 shows suitable for FIG. 3 a schematic time chart with alternating switching states.

### DETAILED DESCRIPTION OF THE PREFERRED EMBODIMENTS

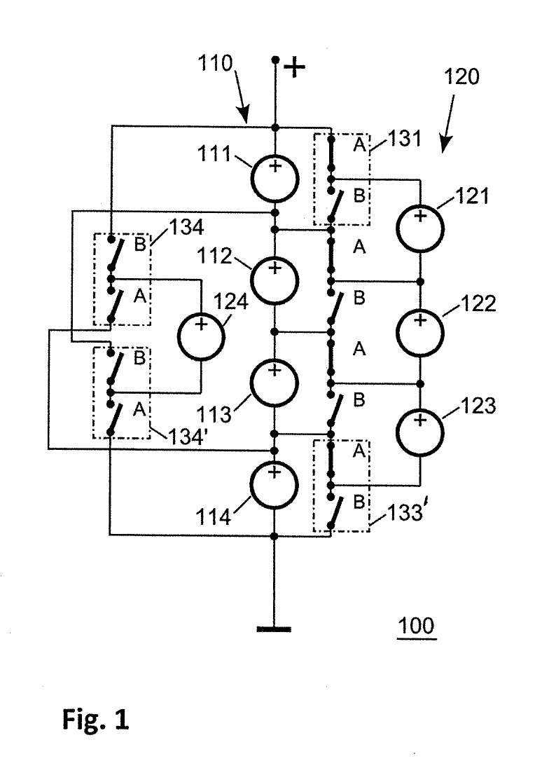

The FIG. 1 shows the structure of a battery 100 according to the invention, the battery comprising a first string 110 (predetermined series connection) which consists of a plurality of series-connected first accumulator cells 111, 112, 113 and 114. By way of example only, there are N=4 cells connected in series and form a first galvanic line having the N-fold cell voltage. If, for example, at least N=100 lithium-ion cells would be connected in series a voltage of more than 300 volts can be achieved, such as is required for batteries for electric vehicles. Also, several such rows (strings) can be connected in parallel. The cell voltages within such a string can differ slightly from each other (e.g. by several 100 millivolts) and thus a charge imbalance can arise.

To equalize the charge (balancing) there are used (N=4) cells 121, 122, 123 and 124 which are switched by means of (N+2) switching elements 131, 132, 133, 133′ and 134 and 134′ and form a further string 120 which represents basically the same galvanic series as string 110 and therefore also contributes to the total capacity of the battery. The charge equalization is carried out with the aid of these second cells 121 to 124; there is no need for compensation means and additional components, such as capacitors, coils etc. The charge balancing is essentially achieved by means of alternately changing the interconnection of the second cells (string 120) with the first cells (string 110) according to the method described in more detail below. It should be noted that in the string 120 the N−1 cells are connected at first in series (here, the cells 121 to 123) and that the other cell 124 can switched by the associated switching elements 134 and 134′ to the one end (upper end before the cell 121) or to the lower end (after the cell 123). By the further switching elements 131 to 133 and by one of said switching elements 134 or 134′ all cells 121 to 124 of the string 120 can then be switched in parallel to the cells of the string 110.

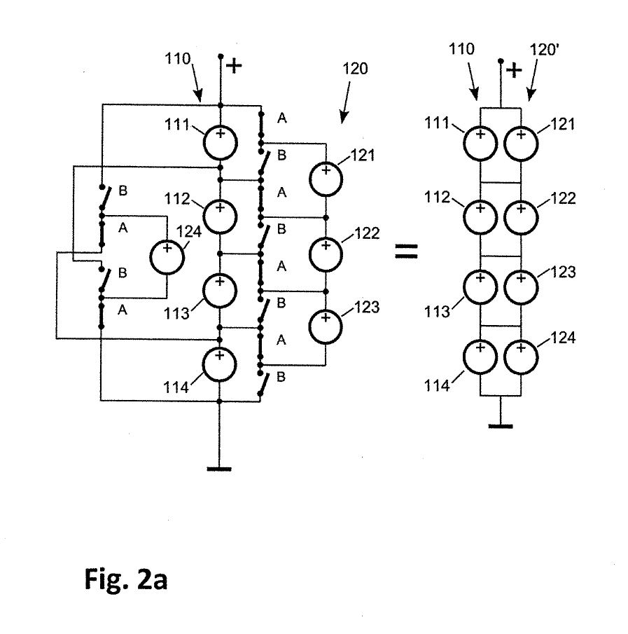

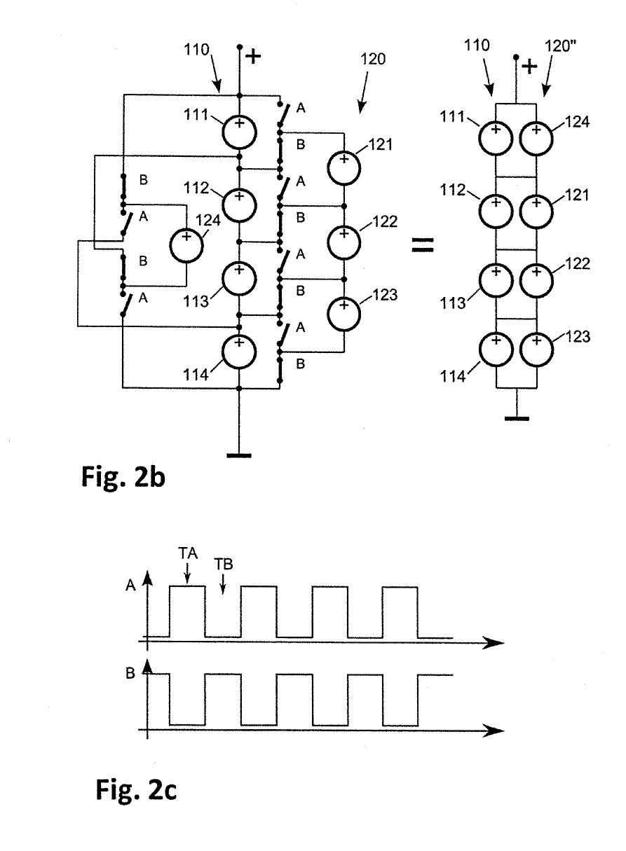

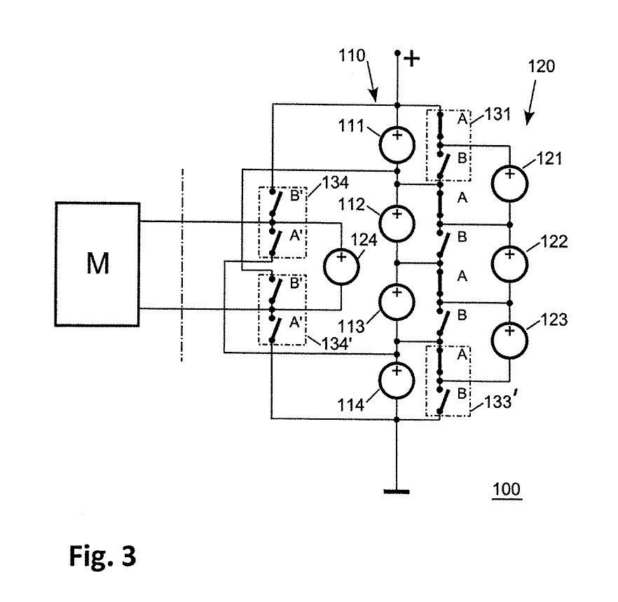

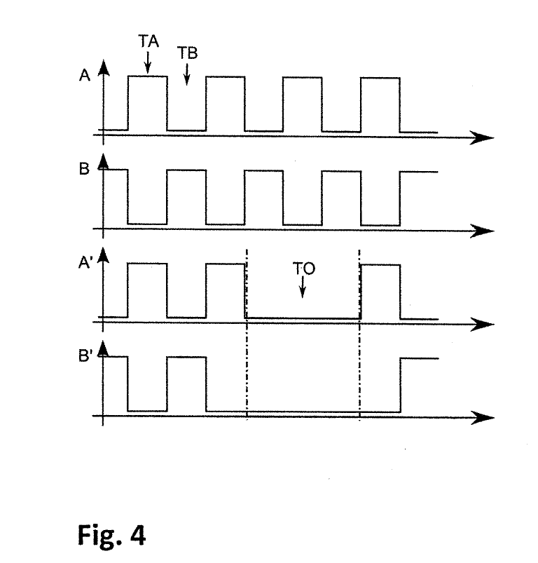

The principle of alternating switching and then operating method for operating the battery will now be described in more detail, wherein reference is also made to the FIGS. 2a and 2b and 2c. With reference to FIGS. 3 and 4 it will also be described below, how a determination of the charge status of the battery can be performed by using the inventive battery structure. Thus, the invention enables both a balancing during operation as well as an accurate determination of the charge state.

According to the switching principle being proposed here and illustrated in FIG. 1, the battery 100 is built by several individual cells 111-114 and 121-124 by series-parallel-circuitry. The battery is subdivided in a string 110 with the first cells 111-114 (fixed order) and a string 120 with the additional (second) cells 121-124 (alternating switching). The string 120 is connected to string 110 by the switching elements 131-133 and 134 and 134′, as it is illustrated in FIG. 1. Further, several strings can be switched in parallel, in order to increase the capacity of the battery 100. As switching elements, each type of switch can be used, preferably semiconductor switching elements, such as MOSFETs, or mechanical switches, such as relays. Each switching element or each group of two switching elements can switch reciprocating in the manner of a two-way switch between two switching states A and B. This is illustrated symbolically in FIG. 1 by the individual switches A and B.

By a phase-delayed switching of the switch elements (e.g. 131) into the state A or B, the string 110 is connected in a first phase (see time interval T in FIG. 2c) with the cells of the string 120 in a first position (see switch positions A in FIG. 2a) so that the cell 121 is connected in parallel to the cell 111 and the cell 122 is connected in parallel to the cell 112, etc. Thus, the string 120 is located in parallel to the string 110 such that order of the cells in both strings is the same and begins with 111 or 121. Here, the charge states between the respective cells being connected in parallel (e.g. 111 and 121) are similar to each other. The string 120 therefore corresponds to the equivalent circuit 120′ of FIG. 2a.

Then, in a second phase (see time interval TB in FIG. 2c) the position of the cells of the string 120 is displaced to a second position (see switch position B in FIG. 2b) so that then the cell 121 is in parallel with the cell 112 and the cell 122 is in parallel to the cell 113 so that the cell 124 is now connected in parallel to cell 111. Thus, the string 120 is now displaced to the parallel circuitry of string 110, namely in a position being shifted downwardly by one place. The sequence of the cells in the string 110 begins at the cell 111, but the sequence of the string 120 begins with the cell 124, and then proceeds to 121, 123 and 123 (see FIG. 2b). Thus, the string 120 has been shifted one position down. The string 120 corresponds to the equivalent circuit diagram 120″ according to FIG. 2b. Now the charge states of the parallel connected cells is balanced, such as the charge state of cell 111 with that of cell 124. Thereby a charge transfer to the adjacent cells of the string 110 is performed. The same applies for the string 120. The charge transfer finally leads to a complete balancing of all cells charges.

Consequently, the charge balance can be carried out on the charge pump principle, without using additional energy-storage elements (capacitors, inductors). Because the charge equalization is carried out with the battery cells themselves. Thus, a battery with 100 Ah remains in principle a 100 Ah battery, however, with the main difference that, in comparison to conventional structure, the inventive battery structure has been divided internally into two strings and that for the loss-free charge balancing no additional charge- or energy-storage means (capacitors, inductors) are required.

Looking at the structure scheme of the battery in FIG. 1, the series connection of the string 120 initially shows one cell less (N−1 cells on the right side 121-123) than in string 110 (N=4 cells 111-114). The N−1 cells of the string 120 are switched either parallel to the beginning or to the end of the string 110 (see switch position A or B). This means that without additional measures, the bottom or top cells of the string 110 are under higher current load than the rest. To compensate for this asymmetry, a further cell 124 is switched to string 120, said further cell being the top parallel cell (see FIG. 2b) or the bottom parallel cell (see FIG. 2a).

In other words, by positional displacement of the series connection of the N−1 cells 121-123 there is left a place at the top or at the bottom end for additionally switching the N-th cell 124. Thus a complete string 120 or 120′ or 120″ (see FIGS. 2a and 2b) that is connected in parallel to the string 110, can always be established.

All battery cells are therefore loaded equally. The shown battery structure (see FIG. 1 and FIGS. 2a and 2b), consisting of a combination of at least one string 110 with a further string 120 or 120′ or 120″ (including the auxiliary cell 124) is virtually identical to a symmetrical series-parallel connection (N cells in series formed to a string; P parallel strings).

The process of changing the switching of the cells 121-124 has, inter alia, the particular advantage that a charge balance can be carried out under all operating conditions of the battery (charging, discharging, idle and full load). The excess energy of individual cells is without intermediate buffering, redistributed to other cells and is not converted into heat. The proposed balancing method is virtually lossless. Overcharging of individual cells is in principle not possible in this process. The battery and its circuit structure have no switching elements (MOSFETs, relays) in series within the string 110, thereby achieving a minimal internal resistance.

The switching elements 131-134/134′ and optionally the control unit (not shown) are herein also referred to as a “balancer” and can be incorporated into the battery entirely or in partially, or can also be designed separately. The balancer can be changed during operation and can be mended due to its appropriate mechanical design. The balancer circuit contains no inductive components for power transmission, but uses the battery cells themselves for this (double benefit). The circuit has very good EMC characteristics, because in principle a low switching frequency can be applied, e.g. in the range of some hertz, and thus steep current peaks can be avoided.

The balancing process described here relieves inherently weaker cells. The total energy content of the series-parallel connection of the cells will be fully utilized by the circuit principle.

In the prior art, the capacity of the weakest cell determines the total capacity of the battery. This is not the case with the present invention. This leads to additional benefits:
The individual cells of the battery need not be necessarily classified and sorted, prior to the assembly of the battery, in order to achieve the maximum packing capacity.
The total lifetime of the battery increases due to the load removal of weaker cells.

In addition to the balancing function, due to the circuit topology, the invention can also be used, without additional effort for the circuitry, to determine the exact status of the battery during operation. This allows a recalibration of the current balance measurement and will hereinafter with reference to FIGS. 3 and 4 be described in detail:

FIG. 3 shows the battery of FIG. 1 in a state in which the cell 124 is separated from the string 120 and is separately connected to a measuring device M. This state occurs during the normal operation of the battery within a measurement interval TO (see FIG. 4), wherein the switch positions A′ and B′ during the measurement interval TO do not correspond to the switch positions A and B. The cell 124 is used as a reference cell, for a measurement to determine the battery state parameters.

Because a reliable operation of battery systems requires an accurate knowledge of the condition of the battery systems in use. Both the current state of charge (remaining charge to be used) as well as the aging state (loss of capacity or change of the internal resistance) provide information on the operational readiness and operational capability of a battery system.

While the measurement of battery state parameters makes little problems under specified condition in the laboratory, the determination on the other hand makes considerable difficulties during the operation. In most applications, an operational disruption for measuring e.g. the capacity is not permitted or possible.

In the prior art, the charge state during normal operation is determined either by balancing the charge state, wherein a recalibration must be done at certain intervals so that the measured value does not drift away, or the idle voltage is estimated with the help of a battery model based on the terminal voltage and with help of the load voltage characteristic curve the state of charge is determined. However, both methods do not allow accurate determination of the charge state and can lead to significant uncertainties and highly unsteady results. For LiFePO cells, for example, the state of charge estimation is due to the flat U-Q curve in the central region extremely inaccurate.

The inventive measurement method described below does not show these defects. The compensating cell 124 (see FIG. 3), which is used in normal operation to balance the charge between uppermost and lowermost cell of a series circuit (see FIG. 1 and FIG. 2a/b), is now also used for determining characteristic parameters of the cell. By opening at least 3 of the 4 switches of the cell 124 (see FIG. 3), this cell is disconnected from the battery for a certain period of time (see in FIG. 4, the illustrated switch states A′ and B′ in the time interval TO during the disconnection of the cell 124).

The characteristic parameters can thus be determined without additional aids, for example by a simple load voltage measurement for determining the SOC (State of Charge, charge state). This can also be carried out with aids (current sink for discharging; source for charging SOC, determination of capacity and internal resistance). During the measurement of the cell 124, the whole battery can be still operated.

Due to the temporal (interval TO) uncoupling of the cell 124 the resulting asymmetry is already balanced by the steadily and continuously running balancing with the other cells 121-123. After the measurement, the cell 124 is coupled back into the balancing process. With the measurement result of the SOC of the cell 124 the SOC of the entire battery can be reliably recalibrated taking account of the charge balance. Thus a method for the precise determination of the state of charge and the state of aging of a battery module during operation is provided.

The invention is applicable to all types of battery cells and modules, and in particular to those that are used in high-performance batteries.

The invention is therefore particularly suitable for the construction and operation of high-performance batteries.

1. A battery (100) comprising a plurality of accumulator cells of which the N first accumulator cells (111 . . . 114) are connected together in series to at least one cell string (110), wherein said N second accumulator cells (121 . . . 124) are arranged to be individually switched by switching elements (131 . . . 133, 134, 134′) to one of the N first accumulator cells (111 . . . 114) in parallel;
wherein
the switching elements (131 . . . 133, 134, 134′) are adapted to establish two-way connections (A, B) between the first and second accumulator cells, each of the second accumulator cell (121) being alternately switchable in parallel either to a first accumulator cell (111) of the cell string (110) or to another first accumulator cell (112) being adjacent thereto, and in that the second accumulator cells (121 . . . 124) that are switched by said means of switching elements (131 . . . 133, 134, 134′) are connected in series to a second cell string (120, 120′, 120″) that is arranged or connected in parallel to the first cell string (110);
whereby the battery comprises at least two strings of cells, each string including the same number of N cells.

2. The battery (100) of claim 1, wherein the switching elements (131 . . . 133, 134, 134′) are controllable to continuously establish in predetermined intervals of time (TA, TB) said two-way connections (A, B) between the first and second accumulator cells in an alternating manner, so that each second accumulator cell (121) is connected in a first time interval (TA) in parallel to a first accumulator cell (111) and is connected in a second time interval (TB) in parallel to the other adjacent first accumulator cell (112).

3. The battery (100) of claim 1, wherein at least one (124) of the second accumulator cells (121 . . . 124) is connected to a plurality of switching elements (134, 134′) that are adapted to separate said second accumulator cell (124) for at least a predetermined third time interval (TO) from connections with the first and/or second accumulator cells and to connect the second accumulator cell (124) to a measuring device (M).

4. A method of operating a battery (100) comprising:
providing a plurality of accumulator cells of which the N first accumulator cells (111 . . . 114) are connected together in series to at least one cell string (110), wherein said N second accumulator cells (121 . . . 124) are arranged to be individually switched by switching elements (131 . . . 133, 134, 134′) to one of the N first accumulator cells (111 . . . 114) in parallel; and
operating the switching elements (131 . . . 133, 134, 134′) to establish two-way connections (A, B) are established between the first and second accumulator cells, wherein each of the second accumulator cell (121) is alternately switched in parallel either to a first accumulator cell (111) of the cell string (110) or to another first accumulator cell (112) being adjacent to thereto, and in that the second accumulator cells (121 . . . 124) that are switched by said means of switching elements (131 . . . 133, 134, 134′) are connected in series to a second cell string (120, 120′, 120″) that is arranged or connected in parallel to the first cell string (110);
whereby the battery comprises at least two strings of cells, each string including the same number of N cells.

5. The method of claim 4, further comprising controlling the switching elements (131 . . . 133, 134, 134′) to continuously establish in predetermined intervals of time (TA, TB) said two-way connections (A, B) between the first and second accumulator cells in an alternating manner, so that each second accumulator cell (121) is connected in a first time interval (TA) in parallel to a first accumulator cell (111) and is connected in a second time interval (TB) in parallel to the other adjacent first accumulator cell (112).

6. The method of claim 4, further comprising connecting at least one (124) of the second accumulator cell (121 . . . 124) to a plurality of switching elements (134, 134′) that are adapted to separate said second accumulator cell (124) for at least a predetermined third time interval (TO) from connections with the first and/or second accumulator cells and to connect the second accumulator cell (124) to a measuring device (M).

7. The method of claim 4, wherein the predefined first and second time intervals (TA, TB) are of the same length, and are in a range of 0.1 seconds to 120 seconds.

8. The method of claim 4, wherein the predetermined third time interval (T0) is longer than the first and the second interval of time (TA, TB), is up to 5 hours long.
